(19) United States
(12) Patent Application Publication
(10) Pub. No.: US 2014/0225894 A1
(43) Pub. Date: Aug. 14, 2014

(54) 3D-RENDERING METHOD AND DEVICE FOR LOGICAL WINDOW

(71) Applicant: Tencent Technology (Shenzhen) Company Limited, Shenzhen (CN)

(72) Inventors: Ming Huang, Shenzhen (CN); Mengqing Chen, Shenzhen (CN); Qiang Tu, Shenzhen (CN); Chunhua Zhang, Shenzhen (CN)

(73) Assignee: Tencent Technology (Shenzhen) Company Limited, Shenzhen (CN)

(21) Appl. No.: 14/263,328

(22) Filed: Apr. 28, 2014

Related U.S. Application Data
(63) Continuation of application No. PCT/CN2013/086924, filed on Nov. 12, 2013.

(30) Foreign Application Priority Data
Jan. 31, 2013 (CN) 201310037742.7

(51) Int. Cl. G06T 15/20

(52) U.S. Cl. CPC G06T 15/20
USPC 345/427

(57) ABSTRACT

A 3D-rendering method for a logical window is provided, including: drawing a 2D image of a target logical window; projecting the 2D image into a preset 3D coordinate space with aspect ratio of the 2D image being maintained, to obtain a 3D model of the target logical window; performing, in the preset 3D coordinate space, a 3D transformation on the 3D model of the target logical window; acquiring a correcting coordinate value and a correcting ratio value of the 3D model; and perspectively projecting the 3D model after the 3D transformation in the preset 3D coordinate space into a target projection plane. A 3D-rendering device is further provided.

### CROSS REFERENCES TO RELATED APPLICATIONS

This application is a continuation of International application PCT/CN2013/086924, filed on Nov. 12, 2013 which claims the priority to Chinese Patent Application No. 201310037742.7, entitled “3D-RENDERING METHOD AND DEVICE FOR LOGICAL WINDOW”, filed with the Chinese State Intellectual Property Office on Jan. 31, 2013, which are incorporated by reference in their entirety herein.

### FIELD

The present disclosure relates to the field of computer technology, and in particular to a 3D-rendering method and device for a logical window.

### BACKGROUND

Owner draw technology for program development on client side enables a developer to realize more special effects, which makes the program interaction interface more brilliant. With development of 3D (three-dimension) technology, a rendered 3D logical window still can not be obtained from a 2D (two-dimension) logical window by using the existing owner draw technology, and thus the program interface on the client side can only display a logical window Frame with 2D effect.

### SUMMARY

A 3D-rendering method for a logical window is provided according to an embodiment of the present disclosure, including: drawing a 2D image of a target logical window;

projecting the 2D image into a preset 3D coordinate space with aspect ratio of the 2D image being maintained, to obtain a 3D model of the target logical window; performing a preset 3D transformation on the 3D model of the target logical window in the preset 3D coordinate space; acquiring a correcting coordinate value and a correcting ratio value of the 3D model; and perspectively projecting the 3D model after the preset 3D transformation in the preset 3D coordinate space into a target projection plane according to the correcting coordinate value and the correcting ratio value.

Correspondingly, a 3D-rendering device for a logical window is further provided according to an embodiment of the present disclosure, including: a 2D image drawing module, configured to draw a 2D image of a target logical window; a 3D modeling module, configured to project the 2D image into a preset 3D coordinate space with aspect ratio of the 2D image being maintained, to obtain a 3D model of the target logical window; a 3D transformation module, configured to perform a preset 3D transformation on the 3D model of the target logical window in the preset 3D coordinate space; and a perspective projection module, configured to acquire a correcting coordinate value and a correcting ratio value of the 3D model, and perspectively project the 3D image after the 3D transformation in the preset 3D coordinate space into a target projection plane according to the correcting coordinate value and the correcting ratio value.

In the embodiments of the present disclosure, a 3D-rendered target logical window can be obtained by introducing a 3D transformation into full owner draw process of the logical window. Therefore, a program interface with 3D effect is obtained by the full owner draw technology.

### BRIEF DESCRIPTION OF THE DRAWINGS

In order to make the technical solutions according to the embodiments of the present disclosure or according to the prior art clearer, accompany drawings to be used in the description of the embodiments or the prior art will be described briefly below. It is obvious that the accompany drawings in the following description are only some embodiments of the present disclosure. Other accompany drawings may be obtained by those skilled in the art based on these accompany drawings without any creative work.

FIG. 1 is a schematic flow chart of a 3D-rendering method for a logical window according to an embodiment of the present disclosure;

FIG. 2 is a schematic flow chart of acquiring a correcting coordinate value and a correcting ratio value of a 3D model according to an embodiment of the present disclosure;

FIG. 3 is a schematic flow chart of a 3D-rendering method for a logical window according to another embodiment of the present disclosure;

FIG. 4 is a schematic structure diagram of a 3D-rendering device for a logical window according to an embodiment of the present disclosure;

FIG. 5 is another schematic structure diagram of the 3D-rendering device for the logical window according to an embodiment of the present disclosure;

FIG. 6 is a schematic structure diagram of a perspective projection module 440 in a 3D-rendering device for a logical window according to an embodiment of the present disclosure;

FIG. 7 is a schematic diagram of a process for building a 3D model of a target logical window according to an embodiment of the present disclosure; and

FIG. 8 is a schematic diagram of effect of a 3D-transformed target logical window obtained by perspective projection according to an embodiment of the present disclosure.

### DETAILED DESCRIPTION

The technical solutions according to the embodiments of the present disclosure will be described clearly and completely below in conjunction with the accompany drawings of the embodiments of the present disclosure. It is obvious that the described embodiments are only part of embodiments of the present disclosure. All other embodiments obtained by those skilled in the art based on the embodiments in the present disclosure without any creative work belong to the protection scope of the present disclosure.

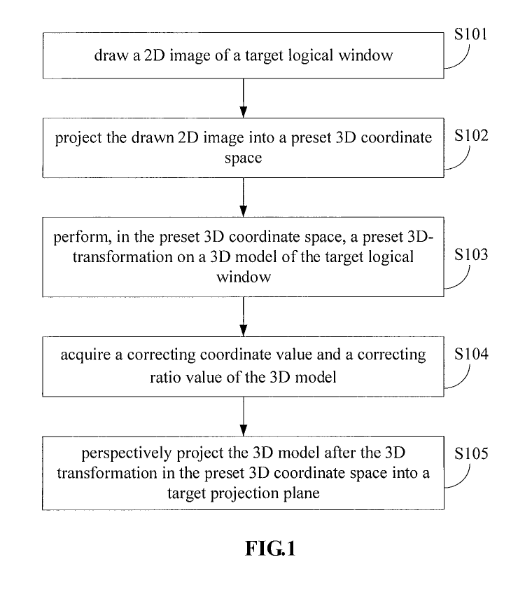

FIG. 1 is a schematic flow chart of a 3D-rendering method for a logical window according to an embodiment of the present disclosure. As shown in FIG. 1, the 3D-rendering process for the logical window according to the embodiment includes the following steps S101 to S105.

S101, drawing a 2D image of a target logical window.

The 3D-rendering method for the logical window in the embodiment may be implemented in a computing device such as a computer, a smart phone and a server. The mentioned logical window may be, for example, a system window Frame, a program window Frame or a control Frame created by the full owner draw technology. In the full owner draw technology, the organizational structure of the logical window Frame is generally as follows: N logical sub-Frames are nested in a top level Frame (or a bottom level Frame), sub-Frames of a next level are nested in each of the N logical sub-Frames similarly, and so on, Frames in multiple nested relationships may be obtained. When a window drawing is triggered, the drawing starts from a top level window, then a first level sub-window subordinate to the top level window, and so on until the drawing of all Frames are finished; therefore, a complete program window is obtained. In drawing a target logical window, it is firstly adjusted whether the target logical window has a 3D attribute. In a case that the target logical window does not have a 3D attribute, the target logical window may be drawn by a drawing method of a 2D logical window. In a case that the target logical window has a 3D attribute, the 3D-rendering process according to the embodiment is performed, where in S101, the 2D image of the target logical window, including a 2D graph and a mapping, is drawn.

S102, projecting the 2D image into a preset 3D coordinate space with aspect ratio of the 2D image being maintained, to obtain a 3D model of the target logic window.

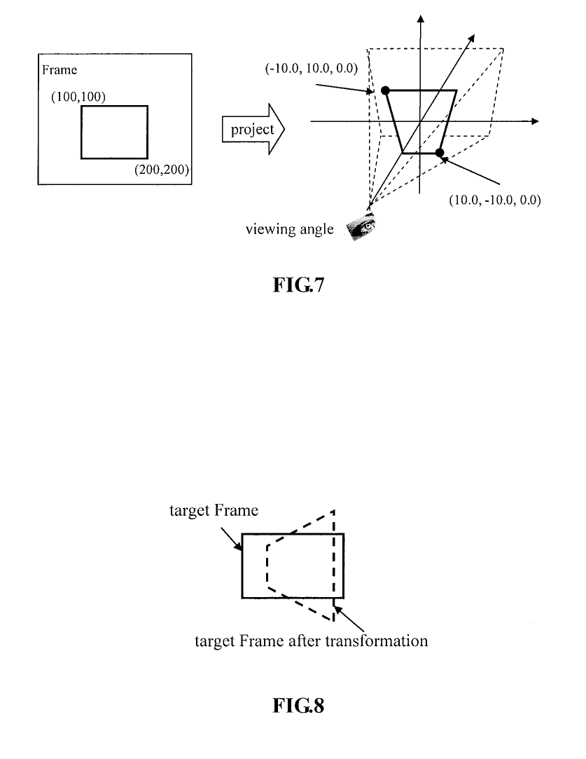

In the process for building the 3D model of the target logical window, a target Frame is mapped into the preset 3D coordinate space, and 3D parameters such as a viewing angle position, a projection plane, a near clip plane and a far clip plane are determined. As shown in FIG. 7, provided that the position of the target Frame on its father Frame (a next higher lever window or a screen) is (100,100,200,200), the target Frame is mapped into the 3D coordinate space with the aspect ratio being maintained, and the final position of the target Frame mapped into the 3D coordinate space is top left corner of (−10.0, 10.0, 0.0) and bottom right corner of (10.0, −10.0, 0.0), as shown in the FIG. 7; therefore, a 3D model for the target Frame is built. The preset 3D coordinate space may be generated according to the 3D parameters predetermined by the user, and the 3D parameters include parameters of a viewing angle position, a projection plane, a near clip plane and a far clip plane.

S103, performing a preset 3D transformation on the 3D model of the target logical window in the preset 3D coordinate space.

In the preset 3D coordinate space, the preset 3D transformation such as translation, zoom, rotation and shear may be performed on the 3D model of the target logical window obtained by projection. The 3D transformation in the embodiment may be triggered by an operation of the user on the target logical window. For example, when the user clicks the target logical window or places a cursor on the target logical window, the 3D-rendering process for the target logical window is triggered, which includes performing, in the preset 3D coordinate space, the preset 3D transformation on the 3D model of the target logical window obtained by projection.

S104, acquiring a correcting coordinate value and a correcting ratio value of the 3D model.

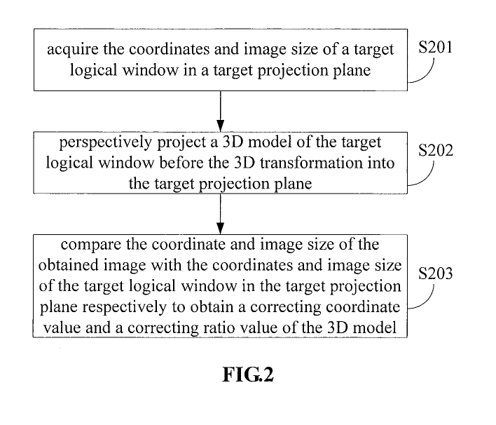

In an implementation, the acquiring a correcting coordinate value and a correcting ratio value of the 3D model in the embodiment may includes steps S201 to S203 shown in FIG. 2.

S201, recording coordinates and image size of the target logical window on its farther logical window or the screen.

S202, perspectively projecting the 3D model of the target logical window before the 3D transformation into a target projection plane, i.e., the father logical window or the screen directly.

S203, respectively comparing coordinates and image size of an image obtained by perspectively projecting the 3D model of the target logical window before the 3D transformation into the target projection plane, with coordinates and image size of the target logical window originally in the target projection plane, to obtain the correcting coordinate value and the correcting ratio value of the 3D model. For example, the correcting coordinate value may be obtained by X=X_{src}−X_{transform} and Y=Y_{src}−Y_{transform}; and the correcting ratio value may be obtained by Ratio=WIDTH_{src}/WIDTH_{transform}, where src indicates the attribute value of the original logical window, and transform indicates the attribute value of the logical window after the transformation. The correcting coordinate value and the correcting ratio value of the 3D model are used to determine an appropriated position and an appropriate size when inversely projecting the 3D model of the target logical window after the 3D transformation into the target projection plane.

S105, perspectively projecting the 3D model after the 3D transformation in the preset 3D coordinate space into the target projection plane according to the correcting coordinate value and the correcting ratio value. The target projection plane is a father logical window of the target logical window or the screen. For example, as shown in FIG. 8, in perspectively projecting the 3D model of the target logical window after a transformation of rotation into the target projection plane, it needs to determine, according to the correcting coordinate value and the correcting ratio value, the coordinate position and window size of the target logical window projected in the target projection plane.

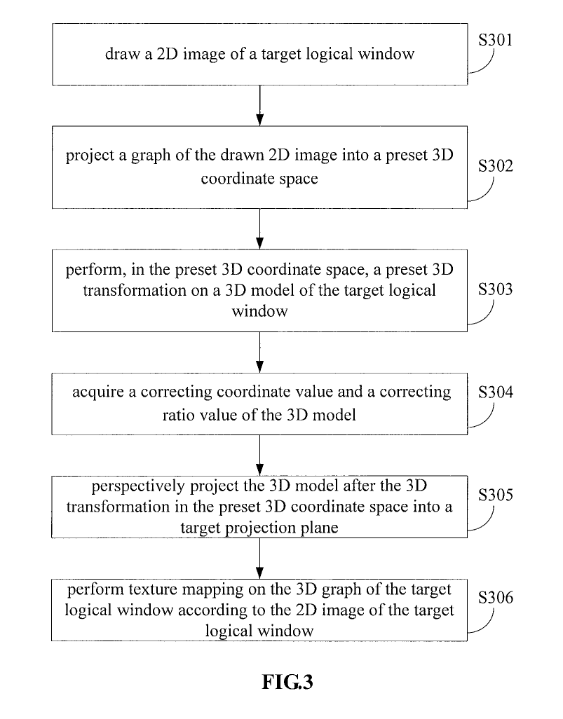

FIG. 3 is a schematic flow chart of a 3D-rendering method for a logical window according to another embodiment of the present disclosure. As shown in FIG. 3, the 3D-rendering method for the target logical window according to the embodiment may include the following steps S301 to S306.

S301, drawing a 2D image of the target logical window. This step is the same as step S101 in the previous embodiment, and thus the detailed description is omitted herein.

S302, projecting the graph of the 2D image of the target logical window into a preset 3D coordinate space, to obtain a 3D model of the target logical window.

In the embodiment, only the graph of the image of the target logical window (for example, the graph surrounded by borders of the image of the target logical window, the mapping of the image within default borders) is projected into the preset 3D coordinate space, to obtain a 3D model of the graph of the target logical window in the 3D coordinate space. The preset 3D coordinate space may be generated according to 3D parameters predetermined by the user, and the 3D parameters include parameters of a viewing angle position, a projection plane, a near clip plane and a far clip plane.

S303, performing a preset 3D transformation on the 3D model of the target logical window in the preset 3D coordinate space. This step is similar to step S103 in the previous embodiment, and thus the detailed description is omitted herein.

S304, acquiring a correcting coordinate value and a correcting ratio value of the 3D model. This step is similar to step S104 in the previous embodiment, and thus the detailed description is omitted herein.

S305, perspectively projecting the 3D model after the 3D transformation into a target projection plane, to obtain a 3D graph of the target logical window.

The target projection plane may be a father logical window of the target logical window or the screen. In the embodiment, for the 3D model of the target logical window, only the graph of the image of the target logical window is projected. In this case, only the 3D graph of the target logical window after the 3D transformation is obtained by projecting in the target projection plane.

S306, performing texture mapping on the 3D graph of the target logical window based on the 2D image of the target logical window.

The texture mapping may be performed on the 3D graph of the target logical window based on the mapping of the 2D image of the target logical window obtained by the drawing in step S301, so that a complete 3D-rendered image of the target logical window may be obtained finally.

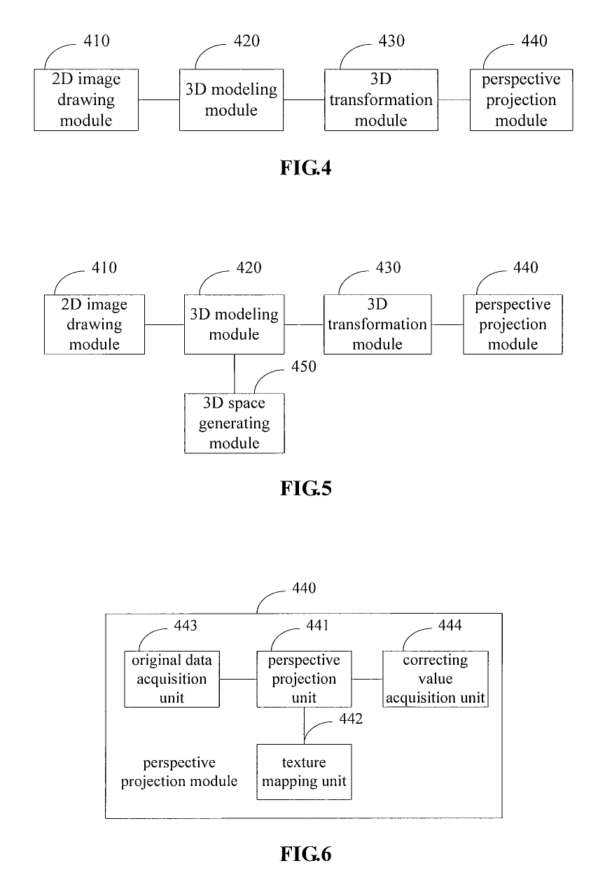

FIG. 4 is a schematic structure diagram of a 3D-rendering device for a logical window according to an embodiment of the present disclosure. The 3D-rendering device for the logical window according to the embodiment may be realized in a computer system such as a computer, a smart phone and a server. As shown in FIG. 4, the 3D-rendering device for the logical window in the embodiment may include the following modules 410 to 440.

A 2D image drawing module 410 is configured to draw a 2D image of a target logical window.

The target logical window may be a program Frame or a control Frame created by the full owner draw technology. In the full owner draw technology, the organizational structure of the logical window Frame is generally as follows: N logical sub-Frames are nested in a top level Frame (or a bottom level Frame), sub-Frames of a next level are nested in each of the N logical sub-Frames similarly, and so on, Frames in multiple nested relationships may be obtained. When a window drawing is triggered, the drawing starts from a top level window, then a first level sub-window subordinate to the top level window, and so on until the drawing of all Frames are finished; therefore, a complete program window is obtained. In drawing a target logical window by the 3D-rendering device for the logical window according to the embodiment, it is firstly adjusted whether the target logical window has a 3D attribute. In a case that the target logical window does not have a 3D attribute, the target logical window may be drawn by using a drawing method of a 2D logical window. In a case that the target logical window has a 3D attribute, the 3D-rendering process needs to be performed, where the 2D image drawing module 410 is configured to draw the 2D image of the target logical window, including a 2D graph and a mapping of the target logical window.

A 3D modeling module 420 is configured to project the 2D image into a preset 3D coordinate space with aspect ratio of the 2D image being maintained, to obtain a 3D model of the target logical window.

In the process for building the 3D model of the target logical window, a target Frame is mapped into the preset 3D coordinate space, and 3D parameters such as a viewing angle position, a projection plane, a near clip plane and a far clip plane are determined. As shown in FIG. 7, provided that the position of the target Frame on its father Frame (a next higher lever window or a screen) is (100,100,200,200), the 3D modeling module 420 maps the target Frame into the 3D coordinate space with the aspect ratio being maintained, and the final position of the target Frame mapped in the 3D coordinate space is top left corner of (−10.0, 10.0, 0.0) and bottom right corner of (10.0, −10.0, 0.0), as shown in the FIG. 7; therefore, a 3D model for the target Frame is built. In an alternative embodiment, the 3D modeling module 420 may project only a graph of the image of the target logical window (for example, a graph surrounded by borders of the image of the target logical window, the mapping of the image within default borders) into the preset 3D coordinate space, to obtain a 3D model of the graph of the target logical window in the 3D coordinate space.

A 3D transformation module 430 is configured to perform a preset 3D transformation on the 3D model of the target logical window in the preset 3D coordinate space.

The 3D transformation module 430 may perform, in the preset 3D coordinate space, a preset 3D transformation such as translation, zoom, rotation and shear on the 3D model of the target logical window obtained by projection. The 3D transformation module 430 in the embodiment may be triggered by an operation of a user on the target logical window. For example, if the user clicks the target logical window or places a cursor on the target logical window, the 3D-rendering process for the target logical window is triggered, including the 3D-transformation module 430 performing, in the preset 3D coordinate space, the preset 3D transformation on the 3D model of the target logical window obtained by projection.

A perspective projection module 440 is configured to acquire a correcting coordinate value and a correcting ratio value of the 3D model, and perspectively project a 3D image after the 3D transformation in the preset 3D coordinate space into a target projection plane according to the correcting coordinate value and the correcting ratio value. The correcting coordinate value and the correcting ratio value are used to determine an appropriated position and an appropriate size when inversely projecting the 3D model of the target logical window after the 3D transformation into the target projection plane. The target projection plane is the father logical window of the target logical window or the screen. As shown in FIG. 8, in perspectively projecting the 3D model of the target logical window after a transformation of rotation into the target projection plane, it needs to determine, according to the correcting coordinate value and the correcting ratio value, the coordinate position and window size of the target logical window projected in the target projection plane.

As shown in FIG. 6, the perspective projection module 440 in the embodiment may further include the following units 441 to 444.

An original data acquiring unit 443 is configured to acquire coordinates and image size of the target logical window in the target projection plane, which may be the original coordinates and image size of the target logical window.

A perspective projection unit 441 is configured to perspectively project the 3D model of the target logical window into the target projection plane. Specifically, the perspective projection unit 441 may be used to perspectively project the 3D model of the target logical window after the 3D transformation into the target projection plane, to obtain a 3D image of the target logical window. In a case that the 3D model of the target logical window only includes the graph of the target logical window, the perspective projection unit 441 may only project the 3D graph of the target logical window into the target projection plane. In order to acquire the correcting coordinate value and the correcting ratio value, the perspective projection unit 441 may perspectively project the 3D model of the target logical window before the 3D transformation into the target projection plane, and the obtained coordinates and image size are compared with the original coordinates and image size acquired by the original data acquisition unit 443.

A correcting value acquiring unit 444 is configured to respectively compare coordinates and image size of an image obtained by perspectively projecting the 3D model of the target logical window before the 3D transformation into the target projection plane, with coordinates and image size of the target logical window in the target projection plane, to obtain the correcting coordinate value and the correcting ratio value of the 3D model.

A texture mapping unit 442 is configured to perform texture mapping on the 3D graph of the target logical window based on the 2D image of the target logical window. In an alternative embodiment, the 3D modeling module 420 only projects the graph of the image of the target logical window to obtain the 3D model of the target logical window, and in this case, only the 3D graph of the target logical window after the 3D transformation is obtained by projecting in the target projection plane. Therefore, the texture mapping unit 442 may perform the texture mapping on the 3D graph of the target logical window based on the mapping of the 2D image of the target logical window drawn by the 2D image drawing module 410, and a complete 3D-rendered image of the target logical window is obtained finally.

Optionally, the 3D-rendering device for the logical window may further include a 3D space generating module 450, which is configured to determine 3D parameters of the 3D coordinate space and generate the 3D coordinate space according to the 3D parameters, as shown in FIG. 5. For example, an interface for inputting a parameter is provided to acquire the 3D parameters input by the user, which include parameters such as a viewing angel position, a projection plane, a near clip plane and a far clip plane, and the preset 3D coordinate space is generated according to the 3D parameter.

In the embodiment of the present disclosure, a 3D-rendered target logical window can be obtained by introducing a 3D transformation into the full owner draw process of the logical window. Therefore, a program interface with 3D effect is obtained by the full owner draw technology.

It should be understood by those skilled in the art that all or part of flows in the method embodiments described above may be achieved by a related hardware which is instructed by a computer program. The program may be stored in a computer readable storage medium, and the program, when being executed by at least one processor of the hardware, may include flows of the method embodiments described above. Specifically, the storage medium may be a diskette, an optical disk, a Read-Only Memory (ROM), or a Random Access Memory (RAM). In one embodiment, the hardware is a computing device such as a computer, a smart phone, a server, and so on.

The above are only preferred embodiments of the present disclosure, which are not used to limit the protection scope of the present disclosure. Therefore, any equivalent changes made in accordance with the claims of the present disclosure fall within the scope of the present disclosure.

1. A method implemented in a computing device for displaying a three-dimensional (3D)-rendering of a logical window displayed at the computing device, the method comprising:
drawing a two-dimensional (2D) image of a target logical window;
projecting the 2D image into a preset 3D coordinate space with aspect ratio of the 2D image being maintained, to obtain a 3D model of the target logical window;
performing a preset 3D transformation on the 3D model of the target logical window in the preset 3D coordinate space;
acquiring a correcting coordinate value and a correcting ratio value of the 3D model; and
perspectively projecting, according to the correcting coordinate value and the correcting ratio value, the 3D model after the preset 3D transformation in the preset 3D coordinate space into a target projection plane.

2. The method of claim 1, wherein projecting the 2D image into a preset 3D coordinate space comprises:
projecting a graph of the 2D image of the target logical window into the preset 3D coordinate space, to obtain the 3D model of the target logical window; and
the perspectively projecting the 3D model after the preset 3D transformation in the preset 3D coordinate space into a target projection plane comprises:
perspectively projecting the 3D model after the preset 3D transformation into the target projection plane, to obtain a 3D graph of the target logical window; and
performing texture mapping on the 3D graph of the target logical window according to the 2D image of the target logical window.

3. The method of claim 1, wherein the acquiring a correcting coordinate value and a correcting ratio value of the 3D model comprises:
acquiring coordinates and image size of the target logical window in the target projection plane;
perspectively projecting the 3D model of the target logical window before the preset 3D transformation into the target projection plane; and
respectively comparing coordinates and image size of an image obtained by perspectively projecting the 3D model of the target logical window before the preset 3D transformation into the target projection plane, with coordinates and image size of the target logical window in the target projection plane, to obtain the correcting coordinate value and the correcting ratio value of the 3D model.

4. The method of claim 1 further comprises; before projecting the 2D image into the preset 3D coordinate space,
determining 3D parameters of the 3D coordinate space; and
generating the 3D coordinate space according to the 3D parameters,
wherein the 3D parameters comprise parameters of a viewing angle position, a projection plane, a near clip plane and a far clip plane.

5. The method of claim 1, wherein the target projection plane is a father logical window of the target logical window or a display screen.

6. The method of claim 2, wherein the target projection plane is a father logical window of the target logical window or a display screen.

7. The method of claim 3, wherein the target projection plane is a father logical window of the target logical window or a display screen.

8. The method of claim 4, wherein the target projection plane is a father logical window of the target logical window or a display screen.

9. A device for rendering a 3D logical window, comprising:
a 2D image drawing module, configured to draw a 2D image of a target logical window;
a 3D modeling module, configured to project the 2D image into a preset 3D coordinate space with aspect ratio of the 2D image being maintained, to obtain a 3D model of the target logical window;
a 3D transformation module, configured to perform a preset 3D transformation on the 3D model of the target logical window in the preset 3D coordinate space; and
a perspective projection module, configured to acquire a correcting coordinate value and a correcting ratio value of the 3D model, and perspectively project the 3D image after the preset 3D transformation in the preset 3D coordinate space into a target projection plane according to the correcting coordinate value and the correcting ratio value.

10. The device of claim 9, wherein the 3D modeling module is configured to:
project a graph of the 2D image of the target logical window into the preset 3D coordinate space to obtain the 3D model of the target logical window; and
the perspective projection module comprises:
a perspective projection unit, configured to perspectively project the 3D model after the preset 3D transformation into the target projection plane, to obtain a 3D graph of the target logical window; and
a texture mapping unit, configured to perform texture mapping on the 3D graph of the target logical window according to the 2D image of the target logical window.

11. The device of claim 9, wherein the perspective projection module comprises:
an original data acquisition unit, configured to acquire coordinates and image size of the target logical window in the target projection plane;
a perspective projection unit, configured to perspectively project the 3D model of the target logical window before the preset 3D transformation into the target projection plane; and
a correcting value acquisition unit, configured to respectively compare coordinates and image size of an image obtained by perspectively projecting the 3D model of the target logical window before the preset 3D transformation into the target projection plane, with coordinates and image size of the target logical window in the target projection plane, to obtain the correcting coordinate value and the correcting ratio value of the 3D model.

12. The device of claim 9, wherein the device further comprises:
a 3D space generating module, configured to determine 3D parameters of the 3D coordinate space and generate the 3D coordinate space according to the 3D parameters, wherein the 3D parameters comprise parameters of a viewing angle position, a projection plane, a near clip plane and a far clip plane.

13. The device of claim 9, wherein the perspective projection module is configured to project the target projection plane as a father logical window of the target logical window or a display screen.

14. The device of claim 10, wherein the perspective projection module is configured to project the target projection plane as a father logical window of the target logical window or a display screen.

15. The device of claim 11, wherein the perspective projection module is configured to project the target projection plane as a father logical window of the target logical window or a display screen.

16. A non-transitory computer-readable medium stored therein a set of processor-executable instructions, which when executed by a processor, cause the processor to execute the steps of:
drawing a 2D image of a target logical window;
projecting the 2D image into a preset 3D coordinate space with aspect ratio of the 2D image being maintained, to obtain a 3D model of the target logical window;
performing a preset 3D transformation on the 3D model of the target logical window in the preset 3D coordinate space;
acquiring a correcting coordinate value and a correcting ratio value of the 3D model; and
perspectively projecting, according to the correcting coordinate value and the correcting ratio value, the 3D model after the preset 3D transformation in the preset 3D coordinate space into a target projection plane.

17. The non-transitory computer-readable medium of claim 16 wherein the processor-executable instructions stored in the computer-readable medium further cause the processor to execute the steps of:
projecting a graph of the 2D image of the target logical window into the preset 3D coordinate space, to obtain the 3D model of the target logical window; and
the perspectively projecting the 3D model after the preset 3D transformation in the preset 3D coordinate space into a target projection plane comprises:
perspectively projecting the 3D model after the preset 3D transformation into the target projection plane, to obtain a 3D graph of the target logical window; and
performing texture mapping on the 3D graph of the target logical window according to the 2D image of the target logical window.

18. The non-transitory computer-readable medium of claim 16 wherein the processor-executable instructions stored in the computer-readable medium further cause the processor to execute the steps of:
acquiring coordinates and image size of the target logical window in the target projection plane;
perspectively projecting the 3D model of the target logical window before the preset 3D transformation into the target projection plane; and
respectively comparing coordinates and image size of an image obtained by perspectively projecting the 3D model of the target logical window before the preset 3D transformation into the target projection plane, with coordinates and image size of the target logical window in the target projection plane, to obtain the correcting coordinate value and the correcting ratio value of the 3D model.

19. The non-transitory computer-readable medium of claim 16 wherein the processor-executable instructions stored in the computer-readable medium further cause the processor to execute, before executing the step of projecting the graph of the 2D image into the preset 3D coordinate space, the steps of:
determining 3D parameters of the 3D coordinate space; and
generating the 3D coordinate space according to the 3D parameters,
wherein the 3D parameters comprise parameters of a viewing angle position, a projection plane, a near clip plane and a far clip plane.

20. The non-transitory computer-readable medium of claim 16 wherein the processor-executable instructions stored in the computer-readable medium further cause the processor to execute the steps wherein the target projection plane is a father logical window of the target logical window or a display screen.
